(19) United States
(12) Patent Application Publication
(10) Pub. No.: US 2016/0148650 A1
(43) Pub. Date: May 26, 2016

(54) VIDEO PROCESSING SYSTEM WITH CUSTOM CHAPTERING AND METHODS FOR USE THEREWITH

(71) Applicant: ViXS Systems, Inc., Toronto (CA)

(72) Inventor: Indra Laksono, Richmond Hill (CA)

(73) Assignee: ViXS Systems, Inc., Toronto (CA)

(21) Appl. No.: 14/552,045

(22) Filed: Nov. 24, 2014

(51) Int. Cl. G11B 27/30; G06K 9/00; G11B 27/00

(52) U.S. Cl. CPC G11B 27/309; G11B 27/3027; G11B 27/002; G06K 9/00765; G06K 9/00744

(57) ABSTRACT

Aspects of the subject disclosure may include, for example, a system receives indexing data delineating a plurality of shots in a video signal that each include a sequence of images of the video signal. The indexing data further indicates content contained in the plurality of shots. A custom chapter generator generates custom chapter data associated with the video signal, based on the indexing data and based on custom chapter parameters, to delineate a plurality of customized chapters of the video signal. Other embodiments are disclosed.

### TECHNICAL FIELD OF THE DISCLOSURE

The present disclosure relates to coding used in devices such as video encoders/decoders.

### DESCRIPTION OF RELATED ART

Many video players allow video content to be navigated on a chapter-by-chapter basis. In particular, an editor selects chapter boundaries in a video corresponding to, for example, the major plot developments. A user that starts or restarts a video can select to begin at any of these chapters. While these systems appear to work well for motion pictures, other content does not lend itself to this type of chaptering.

Further limitations and disadvantages of conventional and traditional approaches will become apparent to one of ordinary skill in the art through comparison of such systems with the present disclosure.

### BRIEF DESCRIPTION OF THE SEVERAL VIEWS OF THE DRAWINGS

FIG. 1 presents a block diagram representation of a video processing system 102 in accordance with an embodiment of the present disclosure.

FIG. 2 presents a block diagram representation of a video processing system 102 in accordance with an embodiment of the present disclosure.

FIG. 3 presents a block diagram representation of a video processing system 102 in accordance with an embodiment of the present disclosure.

FIG. 4 presents a block diagram representation of a video processing system 102 in accordance with an embodiment of the present disclosure.

FIG. 5 presents a block diagram representation of a pattern recognition module 125 in accordance with a further embodiment of the present disclosure.

FIG. 6 presents a temporal block diagram representation of shot data 154 in accordance with a further embodiment of the present disclosure.

FIG. 7 presents a temporal block diagram representation of index data 115 in accordance with a further embodiment of the present disclosure.

FIG. 8 presents a tabular representation of custom chapter data 132 in accordance with a further embodiment of the present disclosure.

FIG. 9 presents a block diagram representation of custom chapter data in accordance with a further embodiment of the present disclosure.

FIG. 10 presents a block diagram representation of index data 115 and customized chapters in accordance with a further embodiment of the present disclosure.

FIG. 11 presents a block diagram representation of a pattern detection module 175 or 175′ in accordance with a further embodiment of the present disclosure.

FIG. 12 presents a pictorial representation of an image 370 in accordance with a further embodiment of the present disclosure.

FIG. 13 presents a block diagram representation of a supplemental pattern recognition module 360 in accordance with an embodiment of the present disclosure.

FIG. 14 presents a temporal block diagram representation of shot data 154 in accordance with a further embodiment of the present disclosure.

FIG. 15 presents a block diagram representation of a candidate region detection module 320 in accordance with a further embodiment of the present disclosure.

FIG. 16 presents a pictorial representation of an image 380 in accordance with a further embodiment of the present disclosure.

FIGS. 17-19 present pictorial representations of image 390, 392 and 395 in accordance with a further embodiment of the present disclosure.

FIG. 20 presents a block diagram representation of a video distribution system 75 in accordance with an embodiment of the present disclosure.

FIG. 21 presents a block diagram representation of a video storage system 79 in accordance with an embodiment of the present disclosure.

FIG. 22 presents a block diagram representation of a mobile communication device 14 in accordance with an embodiment of the present disclosure.

FIG. 23 presents a flowchart representation of a method in accordance with an embodiment of the present disclosure.

### DETAILED DESCRIPTION OF THE DISCLOSURE INCLUDING THE PRESENTLY PREFERRED EMBODIMENTS

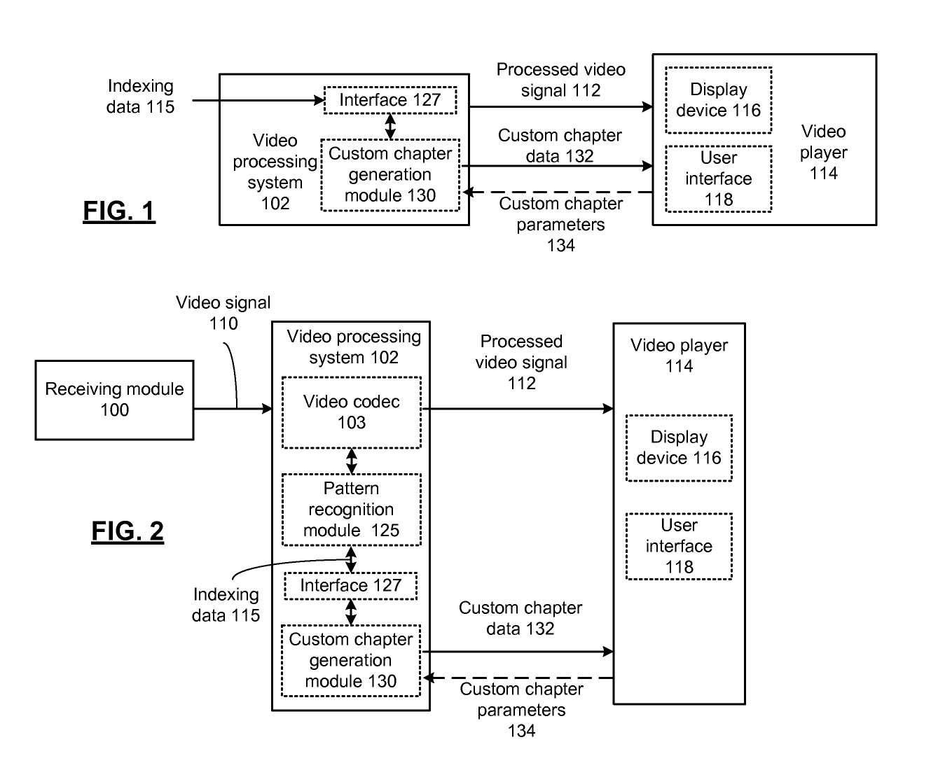

FIG. 1 presents a block diagram representation of a video processing system 102 in accordance with an embodiment of the present disclosure. As media consumption moves from linear to non-linear, advanced methods for searching of content is very popular with consumers. Yet when navigating within a video program, traditional video chaptering and navigation relies on linear methodologies. For example, an editor selects chapter boundaries in a video corresponding to the major plot developments. A user that starts or restarts a video can select to begin at any of these chapters. While these systems appear to work well for motion pictures, other content does not lend itself to this type of chaptering. To address these and other issues and to further enhance the user experience, video processing system 102 includes a custom chapter generator 130 that creates custom chapter data 132 that can be used to navigate video content in a processed video signal 112 in a non-linear, non-contiguous, multilayer and/or other non-traditional fashion.

The video processing system 102 includes an interface 127, such as a wired or wireless interface, a transceiver or other interface that receives indexing data 115 delineating a plurality of shots in the processed video signal 112 that each include a sequence of images of the video signal. The indexing data 115 indicates content contained in the plurality of shots or other characteristics. A custom chapter generator 130 generates custom chapter data 132 associated with the processed video signal 112, based on the indexing data 115 and based on custom chapter parameters 134, to delineate a plurality of customized chapters of the processed video signal 112. Unlike conventional systems, the plurality of customized chapters can be ordered non-linearly and/or can correspond to non-contiguous segments of the video signal—with the plurality of customized chapters collectively including only a proper subset of the video signal.

In one mode of operation, the custom chapter generator 130 generates the custom chapter data 132 to indicate the plurality of customized chapters by comparing the indexing data 115 to the custom chapter parameters and identifying selected ones of the plurality of shots having indexing data that matches, at least in part, the custom chapter parameters 134.

The system also includes a video player 114 that receives the processed video signal 112 and the custom chapter data 132 and, in a first mode of operation, presents the processed video signal 112 for display by a display device 116 in accordance with the a plurality of customized chapters. In an embodiment, the video player 114 generates the custom chapter parameters 134 in response to user input generated by a user interface 118, such as a touch screen, graphical user interface or other user interface device. In another embodiment, the custom chapter parameters 134 can be prestored in the video processing system 102, include one or more default parameters or be received by another network interface not specifically shown. In the first mode of operation, the video player 114 can operate in response to user input generated by a user interface 118 to switch to a second mode of operation where the video signal is displayed in a non-chapterized format from the point in the video signal where the switch occurs.

In various embodiments, the custom chapter parameters 134 can include rules, keywords, metadata and or other parameters that are tailored to the specific requirements of an individual content consumer. The custom chapter generator 130 can apply specific tools either within the home or in the cloud to create non-linear, non-contiguous and/or multi-level chapter points to content of any length. The indexing data 115 received by interface 127 can be extracted from video signal 110 from existing metadata embedded within the video signal 110. In another embodiment, an external device can employ data mining capabilities in audio and video processing to create indexing data 115 in the form of new metadata such as face recognition, colour histogram analysis, and recognition of other patterns within the video. Examples of indexing include the start and stop of music, the appearance and exit of a certain person, place or object. In other modes of operation, the custom chapter generator 130 can delineate chapters based on time periods corresponding to a particular event or action. For example, indexing data 115 can delineate the start and stop of a play that includes a touchdown in a football game or a hit in baseball game.

In a further example, the index data 115 includes a database of metadata items that can grow or shrink dynamically. The database can store unique identifiers that correspond to particular metadata that identify content of the video in a time synchronized fashion. These metadata items can be stored at either a certain event (start of a scene change, shot transition or start of a new Group of Pictures encoding) or a certain time interval (e.g.: every 1 second) or it can be done at every picture. An example of such metadata could be “Sunrise” meaning that particular video content is related to or shows a sunrise. The custom chapter generator 130 can generate custom chapter data 132 that provides a multilevel chaptering derived from such lower level metadata associated with events/time interval/every picture. In particular, the multi-level chapters can be created via known data indexing tools understood in the art, but based on custom chapter parameters 134 that can be specified by the user. If a user wishes to see sunrises, he/she can interact with a user interface to generate custom chapter parameters 134 that specify “sunrises”. The custom chapter generator 130 generates custom chapter data 132 that delineates the video into chapters containing or relating to sunrises. The user can then quickly watch sunrise scenes in a particular movie or each of his movies on a chapter-by-chapter basis. In a similar fashion, if he wishes to see “Gandalf riding a horse” his chaptering can be set to generate a first chapter when Gandalf is riding a horse, and a next-chapter in this context would be the next instance of Gandalf with a horse, etc. The user can navigate one or more video programs in this fashion, reviewing scenes with Gandalf riding a horse, until he/she finds a desired scene.

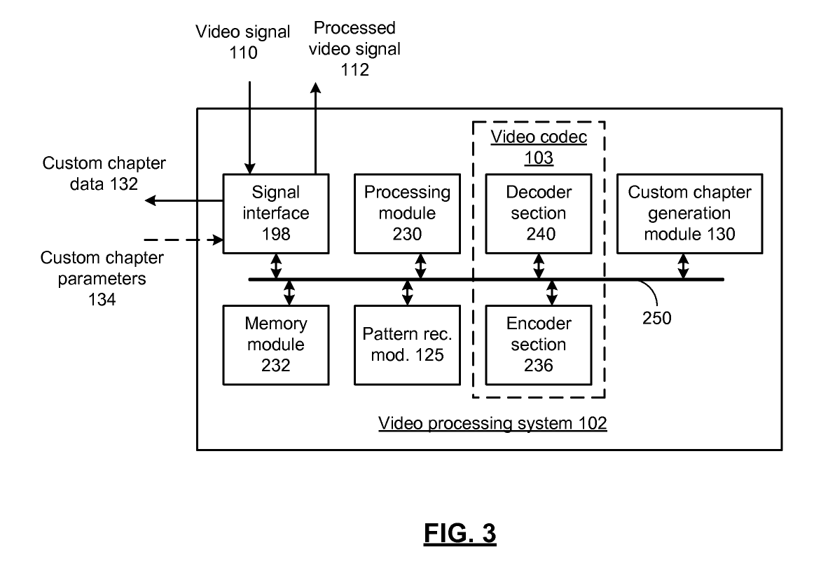

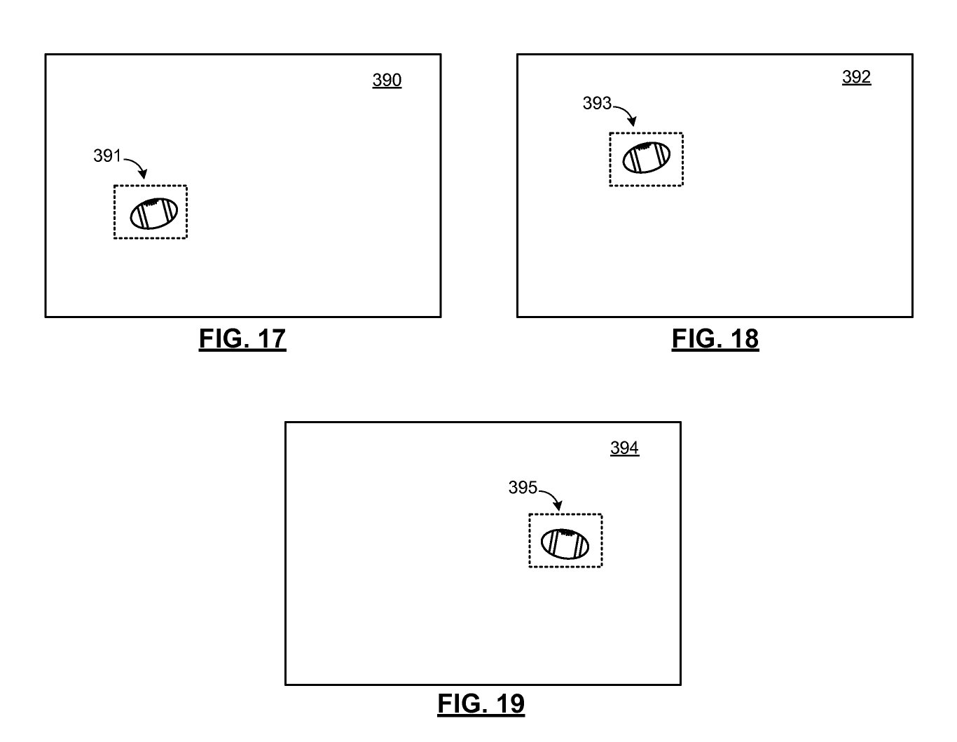

While the processed video signal 112 and custom chapter data 132 are shown separately, in an embodiment, the custom chapter data 132 can be included in the processed video signal, for example, with other metadata of the processed video signal 112. Further, while the video processing system 102 and the video player 114 are shown as separate devices, in other embodiments, the video processing system 102 and the video player can be implemented in the same device, such as a personal computer, tablet, smartphone, or other device. Further examples of the video processing system and video player 114 including several optional functions and features are presented in conjunctions with FIGS. 2-23 that follow.

FIG. 2 presents a block diagram representation of a video processing system 102 in accordance with an embodiment of the present disclosure. While, in other embodiments, the custom chapter generator 130 can be implemented based on indexing data 115 generated in other ways or extracted by other devices, in the embodiment shown, the custom chapter generator 130 is implemented in a video processing system 102 that is coupled to the receiving module 100 to encode, decode and/or transcode one or more of the video signals 110 to form processed video signal 112 via the operation of video codec 103. In particular, the video processing system 102 includes both a video codec 103 and a pattern recognition module 125. In an embodiment, the video processing system 102 processes a video signal 110 received by a receiving module 100 into a processed video signal 112 for use by a video player 114. For example, the receiving module 100, can be a video server, set-top box, television receiver, personal computer, cable television receiver, satellite broadcast receiver, broadband modem, 3G transceiver, network node, cable headend or other information receiver or transceiver that is capable of receiving one or more video signals 110 from one or more sources such as video content providers, a broadcast cable system, a broadcast satellite system, the Internet, a digital video disc player, a digital video recorder, or other video source.

Video encoding/decoding and pattern recognition are both computational complex tasks, especially when performed on high resolution videos. Some temporal and spatial information, such as motion vectors and statistical information of blocks and shot segmentation are useful for both tasks. So if the two tasks are developed together, they can share information and economize on the efforts needed to implement these tasks.

For example, the video codec 103 generates shot transition data that identifies the temporal segments in the video signal corresponding to a plurality of shots. The pattern recognition module 125 generates the indexing data based on shot transition data to identify temporal segments in the video signal corresponding to the plurality of shots. For example, the pattern recognition module 125 can operate via clustering, syntactic pattern recognition, template analysis or other image, video or audio recognition techniques to recognize the content contained in the plurality of shots and to generate indexing data 115 that is coupled to the custom chapter generator 130 via interface 127. The interface 127, in this embodiment, includes a serial or parallel bus, transceiver or other wired or wireless interface.

In an embodiment of the present disclosure, the video signals 110 can include a broadcast video signal, such as a television signal, high definition television signal, enhanced high definition television signal or other broadcast video signal that has been transmitted over a wireless medium, either directly or through one or more satellites or other relay stations or through a cable network, optical network or other transmission network. In addition, the video signals 110 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 and processed video signal 112 can each be differing ones of an analog audio/video (A/V) signal that is formatted in any of a number of analog video formats including National Television Systems Committee (NTSC), Phase Alternating Line (PAL) or Sequentiel Couleur Avec Memoire (SECAM). The video signal 110 and/or processed video signal 112 can each be a digital audio/video signal in an uncompressed digital audio/video format such as high-definition multimedia interface (HDMI) formatted data, International Telecommunications Union recommendation BT.656 formatted data, inter-integrated circuit sound (I2S) formatted data, and/or other digital A/V data formats.

The video signal 110 and/or processed video signal 112 can each be a digital video signal in a compressed digital video format such as H.264, MPEG-4 Part 10 Advanced Video Coding (AVC) or other digital format such as a Moving Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary. When video signal 110 is received as digital video and/or processed video signal 112 is produced in a digital video format, the digital video signal may be optionally encrypted, may include corresponding audio and may be formatted for transport via one or more container formats.

Examples of such container formats are encrypted Internet Protocol (IP) packets such as used in IP TV, Digital Transmission Content Protection (DTCP), etc. In this case the payload of IP packets contain several transport stream (TS) packets and the entire payload of the IP packet is encrypted. Other examples of container formats include encrypted TS streams used in Satellite/Cable Broadcast, etc. In these cases, the payload of TS packets contain packetized elementary stream (PES) packets. Further, digital video discs (DVDs) and Blu-Ray Discs (BDs) utilize PES streams where the payload of each PES packet is encrypted.

In operation, video codec 103 encodes, decodes or transcodes the video signal 110 into a processed video signal 112. The pattern recognition module 125 operates cooperatively with the video codec 103, in parallel or in tandem, and optionally based on feedback data from the video codec 103 generated in conjunction with the encoding, decoding or transcoding of the video signal 110. The pattern recognition module 125 processes image sequences in the video signal 110 to detect patterns of interest. When one or more patterns of interest are detected, the pattern recognition module 125 generates pattern recognition data, in response, that indicates the pattern or patterns of interest. The pattern recognition data can take the form of data that identifies patterns and corresponding features, like color, shape, size information, number and motion, the recognition of objects or features, as well as the location of these patterns or features in regions of particular images of an image sequence as well as the particular images in the sequence that contain these particular objects or features.

The feedback generated by the video codec 103 can take on many different forms. For example, while temporal and spatial information is used by video codec 103 to remove redundancy, this information can also be used by pattern recognition module 125 to detect or recognize features like sky, grass, sea, wall, buildings and building features such as the type of building, the number of building stories, etc., moving vehicles and animals (including people). Temporal feedback in the form of motion vectors estimated in encoding or retrieved in decoding (or motion information gotten by optical flow for very low resolution) can be used by pattern recognition module 125 for motion-based pattern partition or recognition via a variety of moving group algorithms. In addition, temporal information can be used by pattern recognition module 125 to improve recognition by temporal noise filtering, providing multiple picture candidates to be selected from for recognition of the best image in an image sequence, as well as for recognition of temporal features over a sequence of images. Spatial information such as statistical information, like variance, frequency components and bit consumption estimated from input YUV or retrieved for input streams, can be used for texture based pattern partition and recognition by a variety of different classifiers. More recognition features, like structure, texture, color and motion characters can be used for precise pattern partition and recognition. For instance, line structures can be used to identify and characterize manmade objects such as building and vehicles. Random motion, rigid motion and relative position motion are effective to discriminate water, vehicles and animal respectively. Shot transition information from encoding or decoding that identifies transitions between video shots in an image sequence can be used to start new pattern detecting and reorganization and provide points of demarcation for temporal recognition across a plurality of images.

In addition, feedback from the pattern recognition module 125 can be used to guide the encoding or transcoding performed by video codec 103. After pattern recognition, more specific structural and statistical information can be retrieved that can guide mode decision and rate control to improve quality and performance in encoding or transcoding of the video signal 110. Pattern recognition can also generate feedback that identifies regions with different characteristics. These more contextually correct and grouped motion vectors can improve quality and save bits for encoding, especially in low bit rate cases. After pattern recognition, estimated motion vectors can be grouped and processed in accordance with the feedback. In particular, pattern recognition feedback can be used by video codec 103 for bit allocation in different regions of an image or image sequence in encoding or transcoding of the video signal 110. With pattern recognition and the codec running together, they can provide powerful aids to each other.

FIG. 3 presents a block diagram representation of a video processing system 102 in accordance with an embodiment of the present disclosure. In particular, video processing system 102 includes a video codec 103 having decoder section 240 and encoder section 236 that operates in accordance with many of the functions and features of the H.264 standard, the MPEG-4 standard, VC-1 (SMPTE standard 421M) or other standard, to decode, encode, transrate or transcode video signals 110 that are received via a signal interface 198 to generate the processed video signal 112.

In conjunction with the encoding, decoding and/or transcoding of the video signal 110, the video codec 103 generates or retrieves the decoded image sequence of the content of video signal 110 along with coding feedback for transfer to the pattern recognition module 125. The pattern recognition module 125 operates based on an image sequence to generate pattern recognition data and indexing data 115 and optionally pattern recognition feedback for transfer back the video codec 103. In particular, pattern recognition module 125 can operate via clustering, statistical pattern recognition, syntactic pattern recognition or via other pattern detection algorithms or methodologies to detect a pattern of interest in an image or image sequence (frame or field) of video signal 110 and generate pattern recognition data and indexing data 115 in response thereto. The custom chapter generator 130 generates custom chapter data 132 associated with the processed video signal 112, based on the indexing data 115 and based on custom chapter parameters 134 received via signal interface 198 and/or stored in memory module 232, to delineate a plurality of customized chapters of the processed video signal 112. The custom chapter data 132 can be output via the signal interface 198 in association with the processed video signal 112. While shown as separate signals custom chapter data 132 can be provided as metadata to the processed video signal 112 and incorporated in the signal itself as a watermark, video blanking signal or as other data within the processed video signal 112.

The processing module 230 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 232. Memory module 232 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 230 and memory module 232 are coupled, via bus 250, to the signal interface 198 and a plurality of other modules, such as pattern recognition module 125, custom chapter generator 130, decoder section 240 and encoder section 236. In an embodiment of the present disclosure, the signal interface 198, video codec 103, custom chapter generator 130, and pattern recognition module 125 each operate in conjunction with the processing module 230 and memory module 232. The modules of video processing system 102 can each be implemented in software, firmware or hardware, depending on the particular implementation of processing module 230. It should also be noted that the software implementations of the present disclosure can be stored on a tangible storage medium such as a magnetic or optical disk, read-only memory or random access memory and also be produced as an article of manufacture. While a particular bus architecture is shown, alternative architectures using direct connectivity between one or more modules and/or additional busses can likewise be implemented in accordance with the present disclosure.

FIG. 4 presents a block diagram representation of a video processing system 102 in accordance with an embodiment of the present disclosure. As previously discussed, the video codec 103 generates the processed video signal 112 based on the video signal, retrieves or generates image sequence 310 and further generates coding feedback data 300. While the coding feedback data 300 can include other temporal or spatial encoding information, the coding feedback data 300 includes shot transition data that identifies temporal segments in the image sequence corresponding to a plurality of video shots that each include a plurality of images in the image sequence 310.

The pattern recognition module 125 includes a shot segmentation module 150 that segments the image sequence 310 into shot data 154 corresponding to the plurality of shots, based on the coding feedback data 300. A pattern detection module 175 analyzes the shot data 154 and generates pattern recognition data 156 that identifies at least one pattern of interest in conjunction with at least one of the plurality of shots.

In an embodiment, the shot segmentation module 150 operates based on coding feedback data 300 that includes shot transition data 152 generated, for example, by preprocessing information, like variance and downscaled motion cost in encoding; and based on reference and bit consumption information in decoding. Shot transition data 152 can not only be included in coding feedback data 300, but also generated by video codec 103 for use in GOP structure decision, mode selection and rate control to improve quality and performance in encoding.

For example, encoding preprocessing information, like variance and downscaled motion cost, can be used for shot segmentation. Based on their historical tracks, if variance and downscaled motion cost change dramatically, an abrupt shot transition happens; when variances keep changing monotonously and motion costs jump up and down at the start and end points of the monotonous variance changes, there is a gradual shot transition, like fade-in, fade-out, dissolve, and wipe. In decoding, frame reference information and bit consumption can be used similarly. The output shot transition data 152 can be used not only for GOP structure decision, mode selection and rate control to improve quality and performance in encoding, but also for temporal segmentation of the image sequence 310 and as an enabler for frame-rate invariant shot level searching features.

Indexing data 115 can include one or more text strings or other identifiers that indicate patterns of interest for use in characterizing segments of the video signal for chaptering. In addition to use by custom chapter generator 130, the custom chapter data 132 can include such index data 115 and be used in video storage and retrieval, and particularly to find videos of interest (e.g. relating to sports or cooking), locate videos containing certain scenes (e.g. a man and a woman on a beach), certain subject matter (e.g. regarding the American Civil War), certain venues (e.g. the Eiffel Tower) certain objects (e.g. a Patek Phillipe watch), certain themes (e.g. romance, action, horror), etc. Video indexing can be subdivided into five steps: modeling based on domain-specific attributes, segmentation, extraction, representation, organization. Some functions, like shot (temporally and visually connected frames) and scene (temporally and contextually connected shots) segmentation, used in encoding can likewise be used in visual indexing.

In operation, the pattern detection module 175 operates via clustering, statistical pattern recognition, syntactic pattern recognition or via other pattern detection algorithms or methodologies to detect a pattern of interest in an image or image sequence 310 and generates pattern recognition data 156 in response thereto. In this fashion, object/features in each shot can be correlated to the shots that contain these objects and features that can be used for indexing and search of indexed video for key objects/features and the shots that contain these objects/features. The indexing data 115 can be used for scene segmentation in a server, set-top box or other video processing system based on the extracted information and algorithms such as a hidden Markov model (HMM) algorithm that is based on a priori field knowledge.

Consider an example where video signal 110 contains a video broadcast. Indexing data 115 that indicates anchor shots and field shots shown alternately could indicate a news broadcast; crowd shots and sports shots shown alternately could indicate a sporting event. Scene information can also be used for rate control, like quantization parameter (QP) initialization at shot transition in encoding. Indexing data 115 can be used to generate more high-level motive and contextual descriptions via manual review by human personnel. For instance, based on results mentioned above, operators could process indexing data 115 to provide additional descriptors for an image sequence 310 to, for example, describe an image sequence as “around 10 people (Adam, Brian . . . ) watching a live Elton John show on grass under the sky in the Queen's Park.”

The indexing data 115 can contain pattern recognition data 156 and other hierarchical indexing information like: frame-level temporal and spatial information including variance, global motion and bit number etc.; shot-level objects and text string or other descriptions of features such as text regions of a video, human and action description, object information and background texture description etc.; scene-level represents such as video category (news cast, sitcom, commercials, movie, sports or documentary etc.), and high-level context-level descriptions and presentations presented as text strings, numerical classifiers or other data descriptors.

In addition, pattern recognition feedback 298 in the form of pattern recognition data 156 or other feedback from the pattern recognition module 125 can be used to guide the encoding or transcoding performed by video codec 103. After pattern recognition, more specific structural and statistical information can be generated as pattern recognition feedback 298 that can, for instance, guide mode decision and rate control to improve quality and performance in encoding or transcoding of the video signal 110. Pattern recognition module 125 can also generate pattern recognition feedback 298 that identifies regions with different characteristics. These more contextually correct and grouped motion vectors can improve quality and save bits for encoding, especially in low bit rate cases. After pattern recognition, estimated motion vectors can be grouped and processed in accordance with the pattern recognition feedback 298. In particular, the pattern recognition feedback 298 can be used by video codec 103 for bit allocation in different regions of an image or image sequence in encoding or transcoding of the video signal 110.

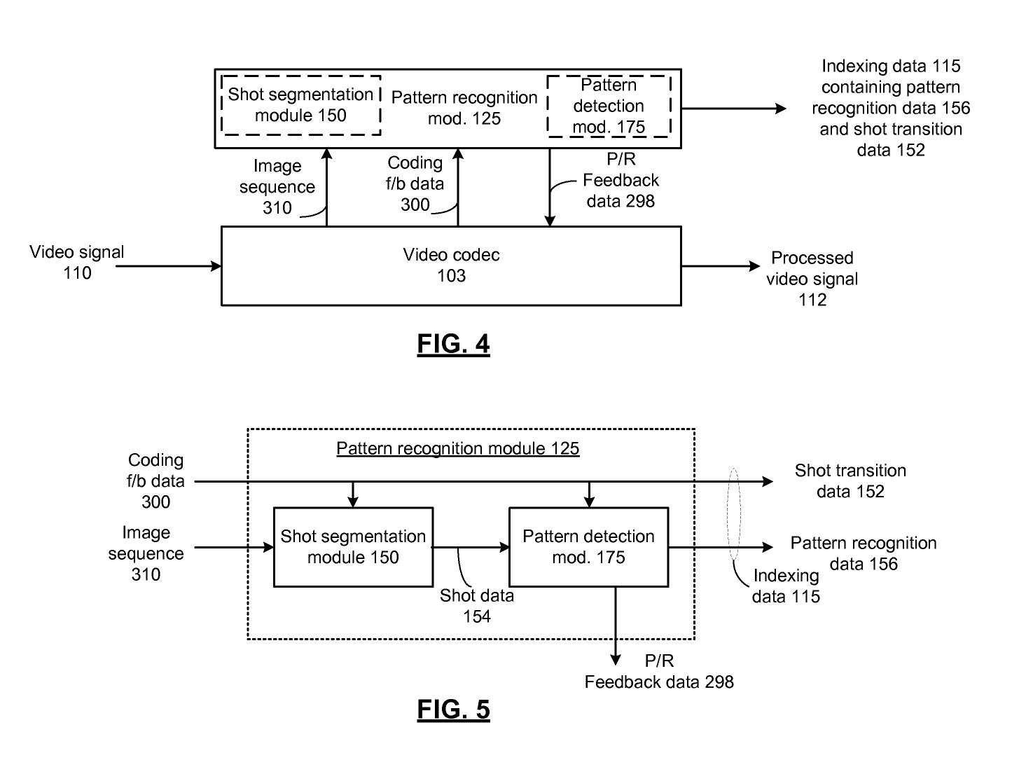

FIG. 5 presents a block diagram representation of a pattern recognition module 125 in accordance with a further embodiment of the present disclosure. As shown, the pattern recognition module 125 includes a shot segmentation module 150 that segments an image sequence 310 into shot data 154 corresponding to a plurality of shots, based on the coding feedback data 300, such as shot transition data 152. The pattern detection module 175 analyzes the shot data 154 and generates pattern recognition data 156 that identifies at least one pattern of interest in conjunction with at least one of the plurality of shots.

The coding feedback data 300 can be generated by video codec 103 in conjunction with either a decoding of the video signal 110, an encoding of the video signal 110 or a transcoding of the video signal 110. The video codec 103 can generate the shot transition data 152 based on image statistics group of picture data, etc. As discussed above, encoding preprocessing information, like variance and downscaled motion cost, can be used to generate shot transition data 152 for shot segmentation. Based on their historical tracks, if variance and downscaled motion cost change dramatically, an abrupt shot transition happens; when variances keep changing monotonously and motion costs jump up and down at the start and end points of the monotonous variance changes, there is a gradual shot transition, like fade-in, fade-out, dissolve, and wipe. In decoding, frame reference information and bit consumption can be used similarly. The output shot transition data 152 can be used not only for GOP structure decision, mode selection and rate control to improve quality and performance in encoding, but also for temporal segmentation of the image sequence 310 and as an enabler for frame-rate invariant shot level searching features.

Further coding feedback data 300 can also be used by pattern detection module 175. The coding feedback data can include one or more image statistics and the pattern recognition module 125 can generate the pattern recognition data 156 based on these image statistics to identify features such as faces, text, human actions, as well as other objects and features. As discussed in conjunction with FIG. 1, temporal and spatial information used by video codec 103 to remove redundancy can also be used by pattern detection module 175 to detect or recognize features like sky, grass, sea, wall, buildings, moving vehicles and animals (including people). Temporal feedback in the form of motion vectors estimated in encoding or retrieved in decoding (or motion information gotten by optical flow for very low resolution) can be used by pattern detection module 175 for motion-based pattern partition or recognition via a variety of moving group algorithms. Spatial information such as statistical information, like variance, frequency components and bit consumption estimated from input YUV or retrieved for input streams, can be used for texture based pattern partition and recognition by a variety of different classifiers. More recognition features, like structure, texture, color and motion characters can be used for precise pattern partition and recognition. For instance, line structures can be used to identify and characterize manmade objects such as buildings and vehicles. Random motion, rigid motion and relative position motion are effective to discriminate water, vehicles and animal respectively.

In addition to analysis of static images included in the shot data 154, shot data 154 can include a plurality of images in the image sequence 310, and the pattern detection module 175 can generate the pattern recognition data 156 based on a temporal recognition performed over a plurality of images within a shot. Slight motion within a shot and aggregation of images over a plurality of shots can enhance the resolution of the images for pattern analysis, can provide three-dimensional data from differing perspectives for the analysis and recognition of three-dimensional objects and other motion can aid in recognizing objects and other features based on the motion that is detected.

Pattern detection module 175 generates the pattern recognition feedback data 298 as described in conjunction with FIG. 3 or other pattern recognition feedback that can be used by the video codec 103 in conjunction with the processing of video signal 110 into processed video signal 112. The operation of the pattern detection module 175 can be described in conjunction with the following additional examples.

In an example of operation, the video processing system 102 is part of a web server, teleconferencing system security system or set top box that generates indexing data 115 with facial recognition. The pattern detection module 175 operates based on coding feedback data 300 that include motion vectors estimated in encoding or retrieved in decoding (or motion information gotten by optical flow etc. for very low resolution), together with a skin color model used to roughly partition face candidates. The pattern detection module 175 tracks a candidate facial region over the plurality of images and detects a face in the image based on the one or more of these images. Shot transition data 152 in coding feedback data 300 can be used to start a new series of face detecting and tracking.

For example, pattern detection module 175 can operate via detection of colors in image sequence 310. The pattern detection module 175 generates a color bias corrected image from image sequence 310 and a color transformed image from the color bias corrected image. Pattern detection module 175 then operates to detect colors in the color transformed image that correspond to skin tones. In particular, pattern detection module 175 can operate using an elliptic skin model in the transformed space such as a C_{b}Cᵣ subspace of a transformed YC_{b}Cᵣ space. In particular, a parametric ellipse corresponding to contours of constant Mahalanobis distance can be constructed under the assumption of Gaussian skin tone distribution to identify a detected region 322 based on a two-dimension projection in the C_{b}Cᵣ subspace. As exemplars, the 853,571 pixels corresponding to skin patches from the Heinrich-Hertz-Institute image database can be used for this purpose, however, other exemplars can likewise be used in broader scope of the present disclosure.

In an embodiment, the pattern detection module 175 tracks a candidate facial region over the plurality of images and detects a facial region based on an identification of facial motion in the candidate facial region over the plurality of images, wherein the facial motion includes at least one of: eye movement; and the mouth movement. In particular, face candidates can be validated for face detection based on the further recognition by pattern detection module 175 of facial features, like eye blinking (both eyes blink together, which discriminates face motion from others; the eyes are symmetrically positioned with a fixed separation, which provides a means to normalize the size and orientation of the head.), shape, size, motion and relative position of face, eyebrows, eyes, nose, mouth, cheekbones and jaw. Any of these facial features can be used extracted from the shot data 154 and used by pattern detection module 175 to eliminate false detections. Further, the pattern detection module 175 can employ temporal recognition to extract three-dimensional features based on different facial perspectives included in the plurality of images to improve the accuracy of the recognition of the face. Using temporal information, the problems of face detection including poor lighting, partially covering, size and posture sensitivity can be partly solved based on such facial tracking Furthermore, based on profile view from a range of viewing angles, more accurate and 3D features such as contour of eye sockets, nose and chin can be extracted.

In addition to generating pattern recognition data 156 for indexing, the pattern recognition data 156 that indicates a face has been detected and the location of the facial region can also be used as pattern recognition feedback 298. The pattern recognition data 156 can include facial characteristic data such as position in stream, shape, size and relative position of face, eyebrows, eyes, nose, mouth, cheekbones and jaw, skin texture and visual details of the skin (lines, patterns, and spots apparent in a person's skin), or even enhanced, normalized and compressed face images. In response, the encoder section 236 can guide the encoding of the image sequence based on the location of the facial region. In addition, pattern recognition feedback 298 that includes facial information can be used to guide mode selection and bit allocation during encoding. Further, the pattern recognition data 156 and pattern recognition feedback 298 can further indicate the location of eyes or mouth in the facial region for use by the encoder section 236 to allocate greater resolution to these important facial features. For example, in very low bit rate cases the encoder section 236 can avoid the use of inter-mode coding in the region around blinking eyes and/or a talking mouth, allocating more encoding bits should to these face areas.

In a further example of operation, the video processing system 102 is part of a web server, teleconferencing system security system or set top box that generates indexing data 115 with text recognition. In this fashion, text data such as automobile license plate numbers, store signs, building names, subtitles, name tags, and other text portions in the image sequence 310 can be detected and recognized. Text regions typically have obvious features that can aid detection and recognition. These regions have relatively high frequency; they are usually high contrast in a regular shape; they are usually aligned and spaced equally; they tend to move with background or objects.

Coding feedback data 300 can be used by the pattern detection module 175 to aid in detection. For example, shot transition data from encoding or decoding can be used to start a new series of text detecting and tracking Statistical information, like variance, frequency component and bit consumption, estimated from input YUV or retrieved from input streams can be used for text partitioning. Edge detection, YUV projection, alignment and spacing information, etc. can also be used to further partition interest text regions. Coding feedback data 300 in the form of motion vectors can be retrieved for the identified text regions in motion compensation. Then reliable structural features, like lines, ends, singular points, shape and connectivity can be extracted.

In this mode of operation, the pattern detection module 175 generates pattern recognition data 156 that can include an indication that text was detected, a location of the region of text and indexing data 115 that correlates the region of text to a corresponding video shots. The pattern detection module 175 can further operate to generate a text string by recognizing the text in the region of text and further to generate indexing data 115 that includes the text string correlated to the corresponding video shot. The pattern recognition module 175 can operate via a trained hierarchical and fuzzy classifier, neural network and/or vector processing engine to recognize text in a text region and to generate candidate text strings. These candidate text strings may optionally be modified later into final text by post processing or further offline analysis and processing of the shot data.

The pattern recognition data 156 can be included in pattern recognition feedback 298 and used by the encoder section 236 to guide the encoding of the image sequence. In this fashion, text region information can guide mode selection and rate control. For instance, small partition mode can be avoided in a small text region; motions vector can be grouped around text; and high quantization steps can be avoided in text regions, even in very low bit rate case to maintain adequate reproduction of the text.

In another example of operation, the video processing system 102 is part of a web server, teleconferencing system security system or set top box that generates indexing data 115 with recognition of human action. In this fashion and region of human action can be determined along with the determination of human action descriptions such as a number of people, body sizes and features, pose types, position, velocity and actions such as kick, throw, catch, run, walk, fall down, loiter, drop an item, etc. can be detected and recognized.

Coding feedback data 300 can be used by the pattern detection module 175 to aid in detection. For example, shot transition data from encoding or decoding can be used to start a new series of action detecting and tracking Motion vectors from encoding or decoding (or motion information gotten by optical flow etc. for very low resolution) can be employed for this purpose.

In this mode of operation, the pattern detection module 175 generates pattern recognition data 156 that can include an indication that a human was detected, a location of the region of the human and indexing data 115 that includes, for example human action descriptors and correlates the human action to a corresponding video shot. The pattern detection module 175 can subdivide the process of human action recognition into: moving object detecting, human discriminating, tracking, action understanding and recognition. In particular, the pattern detection module 175 can identify a plurality of moving objects in the plurality of images. For example, motion objects can be partitioned from background. The pattern detection module 175 can then discriminate one or more humans from the plurality of moving objects. Human motion can be non-rigid and periodic. Shape-based features, including color and shape of face and head, width-height-ratio, limb positions and areas, tile angle of human body, distance between feet, projection and contour character, etc. can be employed to aid in this discrimination. These shape, color and/or motion features can be recognized as corresponding to human action via a classifier such as neural network. The action of the human can be tracked over the images in a shot and a particular type of human action can be recognized in the plurality of images. Individuals, presented as a group of corners and edges etc., can be precisely tracked using algorithms such as model-based and active contour-based algorithm. Gross moving information can be achieved via a Kalman filter or other filter techniques. Based on the tracking information, action recognition can be implemented by Hidden Markov Model, dynamic Bayesian networks, syntactic approaches or via other pattern recognition algorithm.

The pattern recognition data 156 can be included in pattern recognition feedback 298 and used by the encoder section 236 to guide the encoding of the image sequence. In this fashion, presence and location of human action can guide mode selection and rate control. For instance, inside a shot, moving prediction information, trajectory analysis or other human action descriptors generated by pattern detection module 175 and output as pattern recognition feedback 298 can assist the video codec 103 in motion estimation in encoding.

While many of the foregoing examples have focused on the delineation of shots based on purely video and image data, associated audio data can be used in addition to or in the alternative to video data as a way of delineating and characterizing video segments. For example, one or more shots of a video programs can be delineated based the start and stop of a song, other distinct audio sounds, such as running water, wind or other storm sounds or other audio content of a sound track corresponding to the video signal.

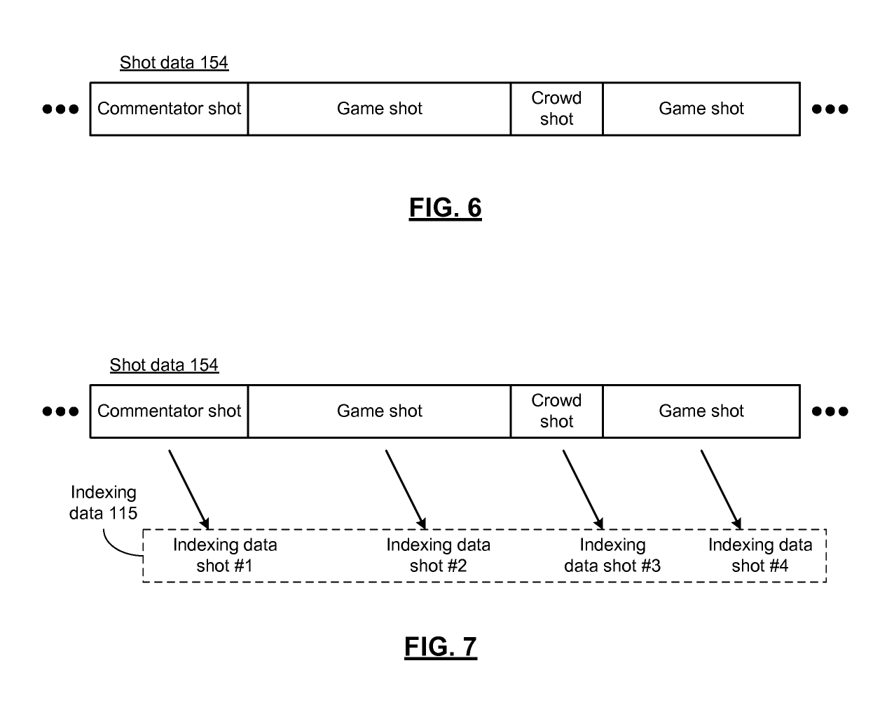

FIG. 6 presents a temporal block diagram representation of shot data 154 in accordance with a further embodiment of the present disclosure. In the example presented, a video signal 110 includes an image sequence 310 of a sporting event such as a football game that is processed by shot segmentation module 150 into shot data 154. Coding feedback data 300 from the video codec 103 includes shot transition data that indicates which images in the image sequence fall within which of the four shots that are shown. A first shot in the temporal sequence is a commentator shot, the second and fourth shots are shots of the game, such as individual plays or other portions of interest, and the third shot is a shot of the crowd.

FIG. 7 presents a temporal block diagram representation of index data 115 in accordance with a further embodiment of the present disclosure. Following with the example of FIG. 6, the pattern detection module 175 analyzes the shot data 154 in the four shots, based on the images included in each of the shots as well as temporal and spatial coding feedback data 300 from video codec 103 to recognize the first shot as being a commentator shot, the second and fourth shots as being shots of the game and the third shot is being a shot of the crowd.

The pattern detection module 175 generates indexing data 115 that includes pattern recognition data 156 in conjunction with each of the shots that identifies the first shot as being a commentator shot, the second and fourth shots as being shots of the game and the third shot is being a shot of the crowd. The pattern recognition data 156 is correlated to the shot transition data 152 to generating indexing data 115 that identifies the location of each shot in the image sequence 310 and to associate each shot with the corresponding pattern recognition data 156, and optionally to identify a region within the shot by image and/or within one or more images that include the identified subject matter.

In an embodiment, the pattern recognition module 125 identifies a football in the scene, the teams that are playing in the game based on analysis of the color and images associated with their uniforms and based on text data contained in the video program. The pattern recognition module 125 can further identify which team has the ball (the team in possession) not only to generate indexing data 115 that characterizes various game shots as plays, but further to characterize the team that is running the play, but also the type of play, a pass, a run, a turnover, a play where player X has the ball, a scoring play that results in a touchdown or field goal, a punt or kickoff, plays that excited the crowd in the stadium, players that were the subject of official review, etc.

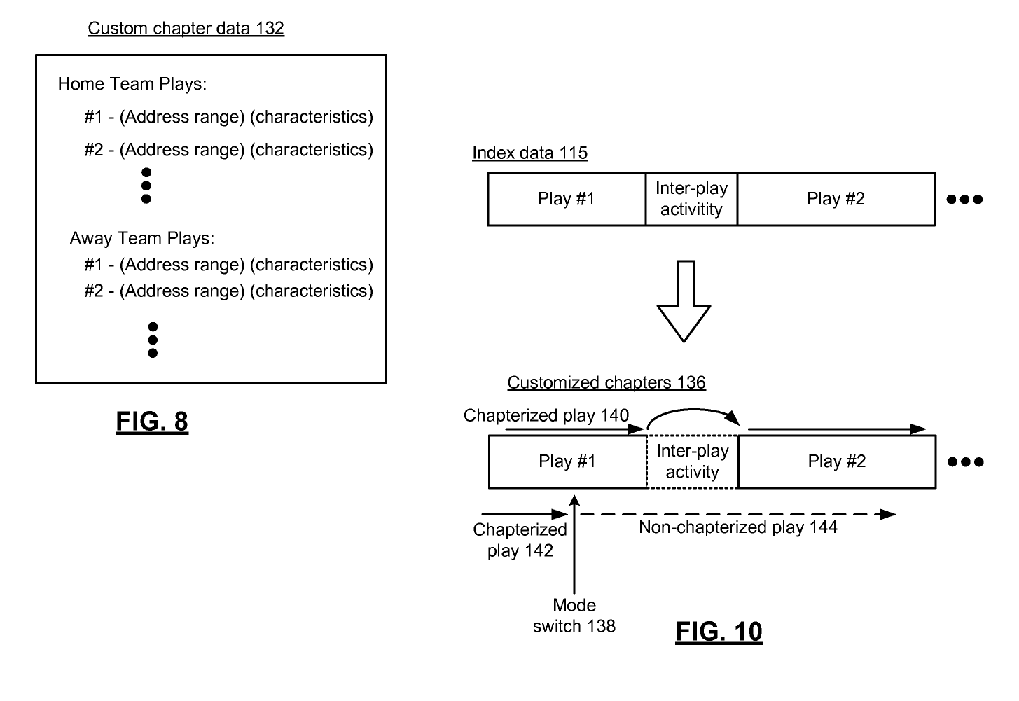

FIG. 8 presents a tabular representation of custom chapter data 132 in accordance with a further embodiment of the present disclosure. In another example in conjunction with FIGS. 6 & 7, a custom chapter data 132 is presented in tabular form where segments of video separated into home team plays and away team plays. Each of the plays are delineated by address ranges and different characteristic of each play, such as association with a particular drive, the type of play, a pass, a run, a turnover, a play where player X has the ball, a scoring play that results in a touchdown or field goal, a punt or kickoff, plays that excited the crowd in the stadium, players that were the subject of official review, etc. The range of images corresponding to each of the plays is indicated by a corresponding address range that can be used to quickly locate a particular play or set of plays within the video.

While the foregoing has focused on one type of custom chapter data 132 for a particular type of content, i.e. a football game, the processing system 102 can operate to generate custom chapter data 132 of different kinds for different sporting events, for different events and for different types of video content such as documentaries, motion pictures, news broadcasts, video clips, infomercials, reality television programs and other television shows, and other content.

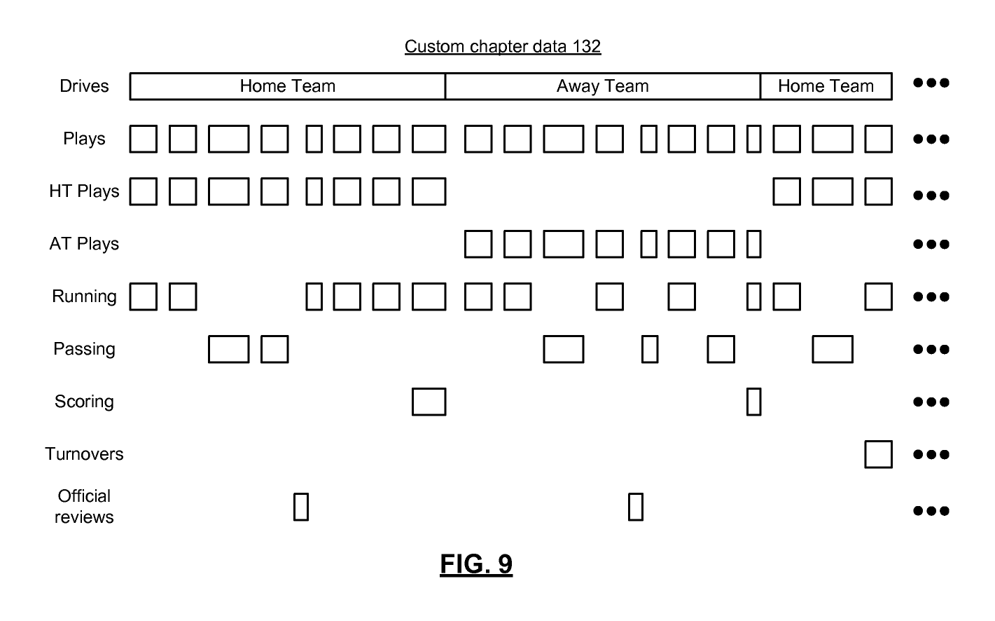

FIG. 9 presents a block diagram representation of custom chapter data 132 in accordance with a further embodiment of the present disclosure. In particular, a further example is shown where index data is generated in conjunction with the processing of video of a football game. This index data is used to generate custom chapter data 132 in multiple layers (or levels) as specified by the custom chapter parameters, corresponding to differing characteristics of segments that make up the game. In particular, the levels shown correspond the drives, plays, home team (HT) plays, away team (AT) plays, running plays, passing plays, scoring plays, turnovers, interplay segments that contain an official review.

The generation of custom chapter data 132 in this fashion allows a user to navigate video content in a processed video signal 112 in a non-linear (i.e., not in linear or temporal order), non-contiguous, multilayer and/or other non-traditional fashion. Consider an example where the user of a video player has downloaded this football game and the associated custom chapter data 132. The user could choose to watch only plays of the home team—in effect, viewing the game in a non-contiguous fashion, skipping over other portions of the game. The user could also view the game out of temporal order by first watching only the scoring plays of the game. If the game seems to be of more interest, the user could change chapter modes to start back from the beginning and watching all of the plays of the game for each team.

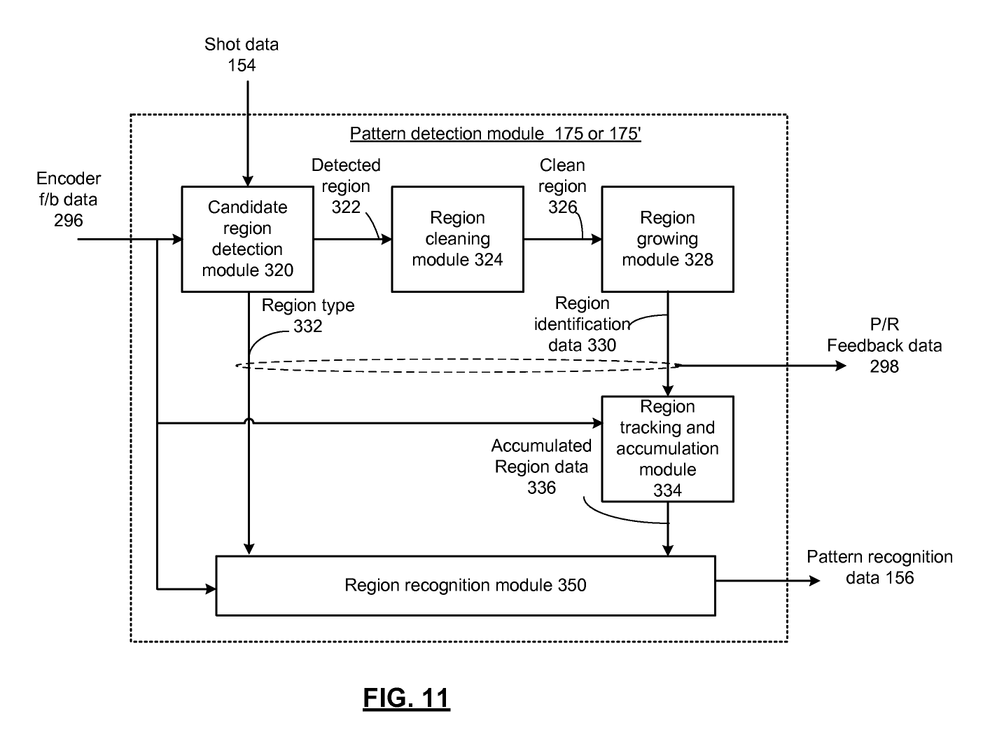

FIG. 10 presents a block diagram representation of index data 115 and customized chapters in accordance with a further embodiment of the present disclosure. In particular, a further example is shown where index data 115 is generated in conjunction with the processing of video of a football game. In this example, a first play of the game (Play #1) contains the kickoff by the away team to the home team. This first play is followed by inter-play activity such as switching the players on the field to begin an offensive drive, a commercial and other inter-play activity. The inter-play activity is followed by play#2, the opening play of the drive by the home team. The indexing data 115 not only identifies an address range that delineates each of these three segments of the video but also includes characteristics that define each segment as being either a play or inter-play activity but optionally includes further characteristics that further characterize or define each play and the inter-play activity.

As previously discussed in conjunction with FIG. 1, the custom chapter generator 130 generates the custom chapter data 132 to indicate the plurality of customized chapters by comparing the indexing data 115 to the custom chapter parameters and identifying selected ones of the plurality of shots having indexing data that matches, at least in part, the custom chapter parameters 134. In this example, the user has defined custom chapter parameters that indicate that a desire to see all kick-offs, plays where the home team is in possession, but only punts, turnovers and scoring plays by the away team, and no interplay activity, except for official reviews. The customized chapter data 132 is used to generate customized chapters that correspond to each play of the game that meets these criteria. In particular, a first chapter includes Play#1 and a second chapter includes play#2.

Consider an example where the user of a video player has downloaded this football game and the associated custom chapter data. The user can begin chapterized play 140 of the game. The first chapter, Play#1 is presented. When completed, the inter-play activity is skipped and the playback automatically resumes with Play#2. In this mode of operation, the customized chapters correspond to non-contiguous segments of the video signal because the inter-play is skipped. As a consequence, the customized chapters collectively include some, but not all, of the video signal, and therefore constitute a proper subset of the full video.

In addition to this form of chapterized play, the video player can operate in response to user input generated by a user interface during the chapterized mode of operation to switch to a second mode of operation where the video signal is displayed in a non-chapterized format from the point in the video signal where the switch occurs. For example, the user begins chapterized play 142, but decides at a point during playback to send signals via the user interface to invoke a mode switch 138 to non-chapterized play 144. In this case, playback of the full video content continues from the point of mode switch 138, playing back the game in a non-chapterized format, the traditional linear playback including all of the video content. Further, while a switch from chapterized play to non-chapterized play is illustrated, a switch from non-chapterized play back to chapterized play can be implemented in a similar fashion. Further, in response to a switch, the user can be given to option to continue play in the different mode from the point that the switch occurs, as shown, or from the beginning of the video or other entry point.

While not expressly shown, in other embodiments, the layered structure of the custom chapter data 132 allows the user to easily switch between different chapterized play modes. For example, the user can start by viewing all home team plays. If the game proves interesting, the user can switch to viewing all plays. At some later point where one team gains a substantial lead, the user can switch to viewing only scoring plays. These present but a few examples of the non-linear, non-contiguous, multilayer and/or other non-traditional navigation that is facilitated by the custom chapter data 132.

FIG. 11 presents a block diagram representation of a pattern detection module 175 or 175′ in accordance with a further embodiment of the present disclosure. In particular, pattern detection module 175 or 175′ includes a candidate region detection module 320 for detecting a detected region 322 in at least one image of image sequence 310. In operation, the candidate region detection module 320 can detect the presence of a particular pattern or other region of interest to be recognized as a particular region type. An example of such a pattern is a human face or other face, human action, text, or other object or feature. Pattern detection module 175 or 175′ optionally includes a region cleaning module 324 that generates a clean region 326 based on the detected region 322, such as via a morphological operation. Pattern detection module 175 or 175′ further includes a region growing module 328 that expands the clean region 326 to generate a region identification data 330 that identifies the region containing the pattern of interest. The identified region type data 332 and the region identification data can be output as pattern recognition feedback data 298.

Considering, for example, the case where the shot data 154 includes a human face and the pattern detection module 175 or 175′ generates a region corresponding the human face, candidate region detection module 320 can generate detected region 322 based on the detection of pixel color values corresponding to facial features such as skin tones. Region cleaning module can generate a more contiguous region that contains these facial features and region growing module can grow this region to include the surrounding hair and other image portions to ensure that the entire face is included in the region identified by region identification data 330.

As previously discussed, the encoder feedback data 296 includes shot transition data, such as shot transition data 152, that identifies temporal segments in the image sequence 310 that are used to bound the shot data 154 to a particular set of images in the image sequence 310. The candidate region detection module 320 further operates based on motion vector data to track the position of candidate region through the images in the shot data 154. Motion vectors, shot transition data and other encoder feedback data 296 are also made available to region tracking and accumulation module 334 and region recognition module 350. The region tracking and accumulation module 334 provides accumulated region data 336 that includes a temporal accumulation of the candidate regions of interest to enable temporal recognition via region recognition module 350. In this fashion, region recognition module 350 can generate pattern recognition data based on such features as facial motion, human actions, three-dimensional modeling and other features recognized and extracted based on such temporal recognition.

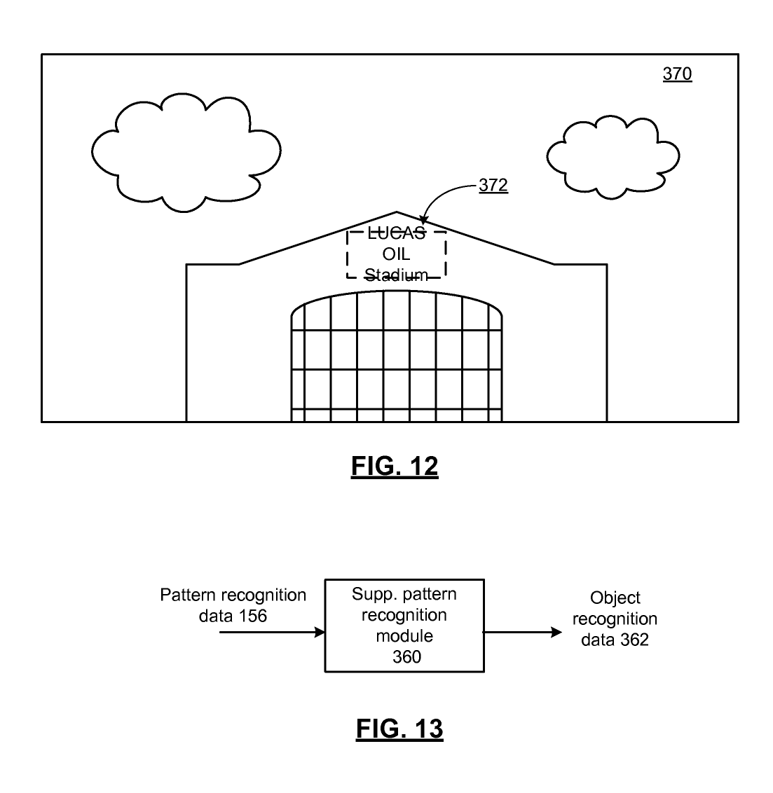

FIG. 12 presents a pictorial representation of an image 370 in accordance with a further embodiment of the present disclosure. In particular, an example image of image sequence 310 is shown that includes a portion of a particular football stadium as part of video broadcast of a football game. In accordance with this example, pattern detection module 175 or 175′ generates region type data 332 included in both pattern recognition feedback data 298 and pattern recognition data 156 that indicates that text is present and region identification data 330 that indicates that region 372 that contains the text in this particular image. The region recognition module 350 operates based on this region 372 and optionally based on other accumulated regions that include this text to generate further pattern recognition data 156 that includes the recognized text string, “Lucas Oil Stadium”.

FIG. 13 presents a block diagram representation of a supplemental pattern recognition module 360 in accordance with an embodiment of the present disclosure. While the embodiment of FIG. 12 is described based on recognition of the text string “Lucas Oil Stadium” via the operation of region recognition module 350, in another embodiment, the pattern recognition data 156 generated by pattern detection module 175 could merely include pattern descriptors, regions types and region data for off-line recognition into feature/object recognition data 362 via supplemental pattern recognition module 360. In an embodiment, the supplemental pattern recognition module 360 implements one or more pattern recognition algorithms. While described above in conjunction with the example of FIG. 12, the supplemental pattern recognition module 360 can be used in conjunction with any of the other examples previously described to recognize a face, a particular person, a human action, or other features/objects indicated by pattern recognition data 156. In effect, the functionality of region recognition module 350 is included in the supplemental pattern recognition module 360, rather than in pattern detection module 175 or 175′.

The supplemental pattern recognition module 360 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. Such a memory may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the supplemental pattern recognition module 360 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

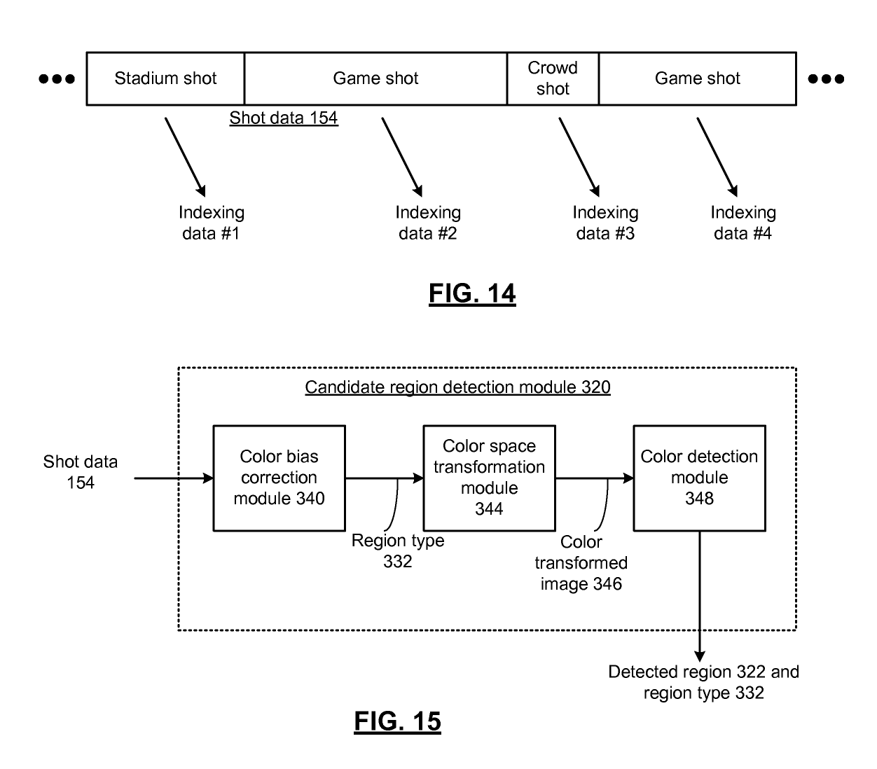

FIG. 14 presents a temporal block diagram representation of shot data 154 in accordance with a further embodiment of the present disclosure. In particular, various shots of shot data 154 are shown in conjunction with the video broadcast of a football game described in conjunction with FIG. 12. The first shot shown is a stadium shot that include the image 370. The indexing data corresponding to this shot includes an identification of the shot as a stadium shot as well as the text string “Lucas Oil Stadium”. The other indexing data indicates the second and fourth shots as being shots of the game and the third shot is being a shot of the crowd.

A previously discussed, the indexing data generated in this fashion could be used to generate a searchable index of this video along with other video as part of a video search system. A user of the video processing system 102 could search videos for “Lucas Oil Stadium” and not only identify the particular video broadcast, but also identify the particular shot or shots within the video, such as the shot containing image 370, that contain a text region, such as text region 372 that generated the search string “Lucas Oil Stadium”.

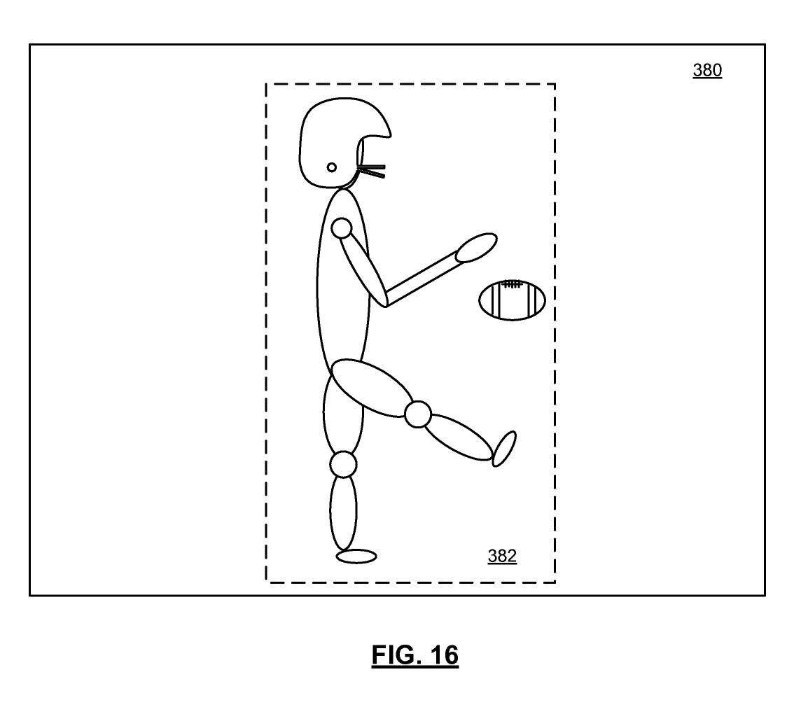

FIG. 15 presents a block diagram representation of a candidate region detection module 320 in accordance with a further embodiment of the present disclosure. In this embodiment, candidate region detection module 320 operates via detection of colors in image sequence 310. Color bias correction module 340 generates a color bias corrected image 342 from image sequence 310. Color space transformation module 344 generates a color transformed image 346 from the color bias corrected image 342. Color detection module generates the detected region 322 from the colors of the color transformed image 346.

For instance, following with the example discussed in conjunction with FIG. 3 where human faces are detected, color detection module 348 can operate to detect colors in the color transformed image 346 that correspond to skin tones using an elliptic skin model in the transformed space such as a C_{b}Cᵣ subspace of a transformed YC_{b}Cᵣ space. In particular, a parametric ellipse corresponding to contours of constant Mahalanobis distance can be constructed under the assumption of Gaussian skin tone distribution to identify a detected region 322 based on a two-dimension projection in the C_{b}Cᵣ subspace and a region type 332 indicating that a face was detected. As exemplars, the 853,571 pixels corresponding to skin patches from the Heinrich-Hertz-Institute image database can be used for this purpose, however, other exemplars can likewise be used in broader scope of the present disclosure.

FIG. 16 presents a pictorial representation of an image 380 in accordance with a further embodiment of the present disclosure. In particular, an example image of image sequence 310 is shown that includes a player punting a football as part of video broadcast of a football game. In accordance with this example, pattern detection module 175 or 175′ generates region type data 332 included in both pattern recognition feedback data 298 and pattern recognition data 156 that indicates that human action is present and region identification data 330 that indicates that region 382 that contains the human action in this particular image. The pattern recognition module 350 or supplemental pattern recognition module 360 operate based on this region 382 and based on other accumulated regions that include similar regions containing the punt to generate further pattern recognition data 156 that includes human action descriptors such as “football player”, “kick”, “punt” or other descriptors that characterize this particular human action.

FIGS. 17-19 present pictorial representations of images 390, 392 and 394 in accordance with a further embodiment of the present disclosure. In particular, example images of image sequence 310 are shown that follow a punted a football as part of video broadcast of a football game. In accordance with this example, pattern detection module 175 or 175′ generates region type data 332 included in both pattern recognition feedback data 298 and pattern recognition data 156 that indicates the presence of an object such as a football is present and region identification data 330 that indicates that regions 391, 393 and 395 contains the football in each corresponding images 390, 392 and 394.

The pattern recognition module 350 or supplemental pattern recognition module 360 operate based on accumulated regions 391, 393 and 395 that include similar regions containing the punt to generate further pattern recognition data 156 that includes human action descriptors such as “football play”, “kick”, “punt”, information regarding the distance, height, trajectory of the ball and/or other descriptors that characterize this particular action.

It should be noted, that while the descriptions of FIGS. 9-19 have focused on an encoder section 236 that generates encoder feedback data 296 and the guides encoding based on pattern recognition feedback data 298, similar techniques could likewise be used in conjunction with a decoder section 240 or transcoding performed by video codec 103 to generate coding feedback data 300 that is used by pattern recognition module 125 to generate pattern recognition feedback data that is used by the video codec 103 or decoder section 240 to guide encoding or transcoding of the image sequence.

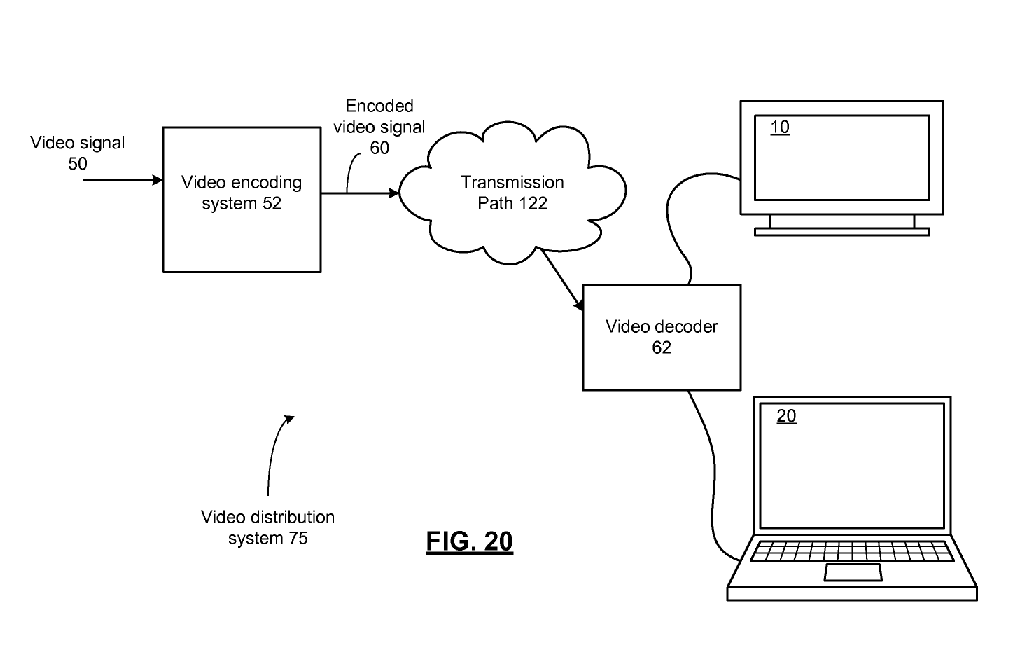

FIG. 20 presents a block diagram representation of a video distribution system 75 in accordance with an embodiment of the present disclosure. In particular, a video signal 50 is encoded by a video encoding system 52 into encoded video signal 60 for transmission via a transmission path 122 to a video decoder 62. Video decoder 62, in turn can operate to decode the encoded video signal 60 for display on a display device such as television 12, computer 20 or other display device. The video processing system 102 can be implemented as part of the video encoding system 52 or the video decoder 62 to generate custom chapter data 132 from the content of video signal 50.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a Universal Serial Bus protocol, an Ethernet protocol or other high speed protocol.

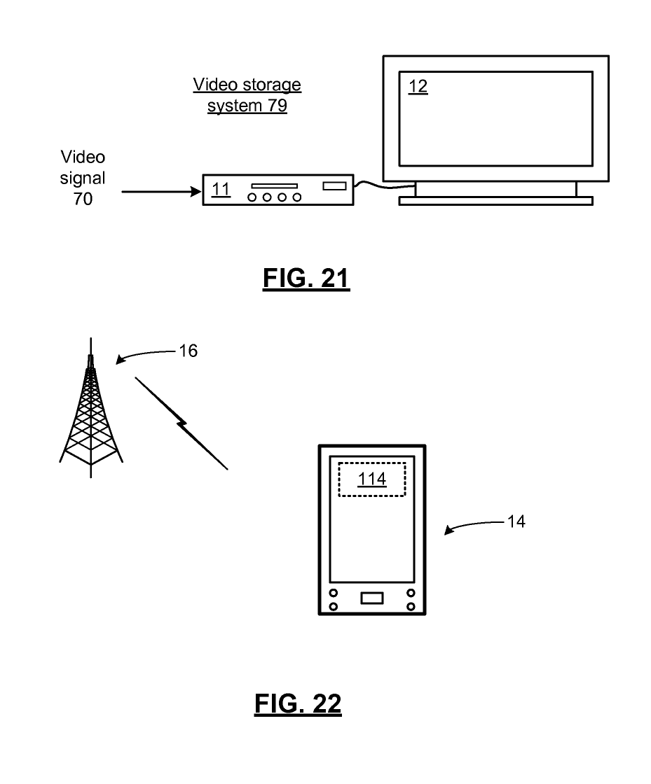

FIG. 21 presents a block diagram representation of a video storage system 79 in accordance with an embodiment of the present disclosure. In particular, device 11 is a set top box with built-in digital video recorder functionality, a stand alone digital video recorder, a DVD recorder/player or other device that records or otherwise stores a digital video signal for display on video display device such as television 12. The video processing system 102 can be implemented in device 11 as part of the encoding, decoding or transcoding of the stored video signal to generate pattern recognition data 156 and/or indexing data 115.

While these particular devices are illustrated, video storage system 79 can include a hard drive, flash memory device, computer, DVD burner, or any other device that is capable of generating, storing, encoding, decoding, transcoding and/or displaying a video signal in accordance with the methods and systems described in conjunction with the features and functions of the present disclosure as described herein.

FIG. 22 presents a block diagram representation of a mobile communication device 14 in accordance with an embodiment of the present disclosure. In particular, a mobile communication device 14, such as a smart phone, tablet, personal computer or other communication device that communicates with a wireless access network via base station or access point 16. The mobile communication device 14 includes a video player 114 to play video content with associated custom chapter data that is downloaded or streamed via such a wireless access network.

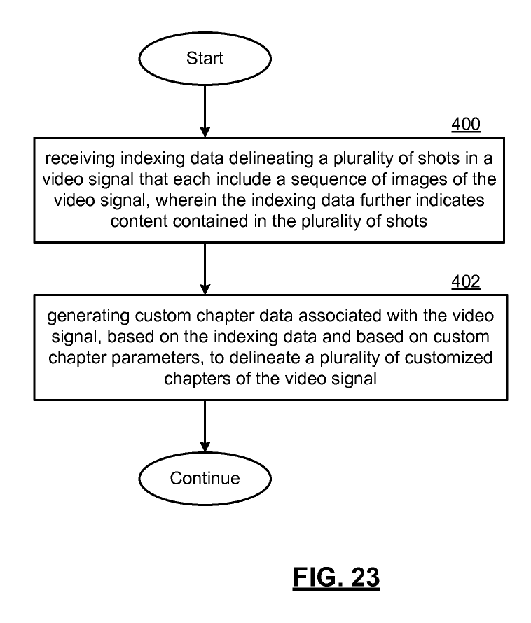

FIG. 23 presents a flowchart representation of a method in accordance with an embodiment of the present disclosure. In particular a method is presented for use in conjunction with one more functions and features described in conjunction with FIGS. 1-22. Step 400 includes receiving indexing data delineating a plurality of shots in a video signal that each include a sequence of images of the video signal, wherein the indexing data further indicates content contained in the plurality of shots. Step 402 includes generating custom chapter data associated with the video signal, based on the indexing data and based on custom chapter parameters, to delineate a plurality of customized chapters of the video signal.

In an embodiment the plurality of customized chapters are ordered non-linearly and/or correspond to non-contiguous segments of the video signal and the plurality of customized chapters collectively include a proper subset of the video signal. The custom chapter data can be generated by comparing the indexing data to the custom chapter parameters and identifying selected ones of the plurality of shots having indexing data that matches, at least in part, the custom chapter parameters. At least one of the plurality of shots can be delineated based on content of a sound track corresponding to the video signal.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

1. A system comprising:
an interface configured to receive indexing data delineating a plurality of shots in a video signal that each include a sequence of images of the video signal, wherein the indexing data further indicates content contained in the plurality of shots; and
a custom chapter generator configured to generate custom chapter data associated with the video signal, based on the indexing data and based on custom chapter parameters selected by a user that indicates at least one content type to be used to delineate a plurality of customized chapters of the video signal;
wherein the custom chapter generator generates the custom chapter data to indicate the plurality of customized chapters by comparing the indexing data to the custom chapter parameters and identifying selected ones of the plurality of shots wherein the content matches the at least one content type indicated by the custom chapter parameters selected by the user.

2. The system of claim 1 further comprising:
a pattern recognition module that generates the indexing data based on shot transition data that identifies temporal segments in the video signal corresponding to the plurality of shots, by recognizing the content contained in the plurality of shots.

3. The system of claim 2 further comprising:
a video codec that generates the shot transition data that identifies the temporal segments in the video signal corresponding to the plurality of shots.

4. The system of claim 1 wherein the plurality of customized chapters are ordered non-linearly.

5. The system of claim 1 wherein the plurality of customized chapters correspond to non-contiguous segments of the video signal and the plurality of customized chapters collectively include a proper subset of the video signal and only the plurality of shots wherein the content matches the at least one content type indicated by the custom chapter parameters selected by the user.

6. The system of claim 1 wherein the at least one content type includes at least one of: a type of sports play, a location, a venue, an object, an event, a character, or a genre.

7. The system of claim 5 further comprising:
a video player that receives the video signal and the custom chapter data and, in a first mode of operation, presents the video signal for display by a display device in accordance with the plurality of customized chapters by playing the plurality of customized chapters in order while skipping portions of the video signal not included in the proper subset of the video signal.

8. The system of claim 7 wherein the video signal corresponds to a sporting event and the at least one content type includes at least one of: a home team play, an away team play, a scoring play or a turnover.

9. The system of claim 7 wherein the video player operates in response to user input generated by a user interface during the first mode of operation to switch from the playing of the plurality of customized chapters in order while skipping the portions of the video signal not included in the proper subset of the video signal to a second mode of operation where the video signal is displayed in a normal and non-chapterized format from a point in the video signal where the switch occurs.

10. The system of claim 1 wherein the at least one content type indicates one or more songs on a sound track corresponding to the video signal.

11. A method comprising:
receiving indexing data delineating a plurality of shots in a video signal that each include a sequence of images of the video signal, wherein the indexing data further indicates content contained in the plurality of shots; and
generating custom chapter data associated with the video signal, based on the indexing data and based on custom chapter parameters selected by a user that indicates at least one content type to be used to delineate a plurality of customized chapters of the video signal.
wherein the the custom chapter data is generated to indicate the plurality of customized chapters by comparing the indexing data to the custom chapter parameters and identifying selected ones of the plurality of shots wherein the content matches the at least one content type indicated by the custom chapter parameters selected by the user.

12. The method of claim 11 wherein the plurality of customized chapters are ordered non-linearly.

13. The method of claim 11 wherein the plurality of customized chapters correspond to non-contiguous segments of the video signal and the plurality of customized chapters collectively include a proper subset of the video signal and only the plurality of shots wherein the content matches the at least one content type indicated by the custom chapter parameters selected by the user.

14. The method of claim 11 wherein the at least one content type includes at least one of: a type of sports play, a location, a venue, an object, an event, a character, or a genre.

15. The method of claim 11 wherein the at least one content type indicates one or more songs on a sound track corresponding to the video signal.
